(19) United States
(12) Patent Application Publication
(10) Pub. No.: US 2026/0220305 A1
(43) Pub. Date: Jul. 30, 2026

(54) DETECTING COPIED TEXT USING KEYSTROKE PATTERN ANALYSIS

(71) Applicant: Check Mate Plagiarism LLC, Burbank, CA (US)

(72) Inventor: Nicholas Mark, Burbank, CA (US)

(21) Appl. No.: 19/039,122

(22) Filed: Jan. 28, 2025

(51) Int. Cl. G06F 21/64; G06F 40/10

(52) U.S. Cl. CPC G06F 21/64; G06F 40/10

(57) ABSTRACT

A method of detecting copied text using keystroke pattern analysis is disclosed. A set of raw revision history data items associated with creation of a document is received. The set of raw revision history data items pertains to one or more modifications made to the document during the creation of the document. The set of raw revision history data items is processed to identify one or more patterns in the set of raw revision history data items. The one or more patterns pertain to characteristics of how content was input into the document. A machine learning model is used to classify one or more portions of the document as either authentically created or copied based on the identifying of the one or more patterns. One or more indicators are caused to be presented in a user interface to represent the classifying of the one or more portions of the document.

### TECHNICAL FIELD

The present disclosure relates generally to document analysis and copy detection systems, and more particularly to systems and methods for detecting copied text through analysis of document revision history data, including using machine learning techniques to analyze typing patterns and editing behaviors captured by document services to distinguish between authentically typed and copied content.

### BACKGROUND

In recent years, artificial intelligence (AI) and machine learning (ML) technologies have advanced rapidly, leading to innovations in understanding and generating natural language content. Specifically, large neural network models called large language models (LLMs) have demonstrated impressive capabilities in language comprehension and text generation.

Document editing and collaboration tools have become increasingly sophisticated, with cloud-based services offering features like real-time collaboration. These services have enabled new workflows for content creation and editing.

Existing approaches for detecting copied or plagiarized content typically rely on comparing text against databases of source material or analyzing writing style characteristics. However, these methods face limitations as text generation capabilities continue to advance.

### BRIEF DESCRIPTION OF THE DRAWINGS

Some embodiments are illustrated by way of example and not limitation in the accompanying drawings.

FIG. 1 illustrates a system architecture diagram showing the main components of the copy detection system.

FIG. 2 shows a document processing pipeline diagram depicting the flow from raw revision history through text chunking and analysis to output generation.

FIG. 3 illustrates a detailed feature extraction process diagram showing how raw revision history data is processed through multiple stages.

FIG. 4 depicts a training data processing diagram showing the preparation of both authentic and copied text examples.

FIG. 5 is a block diagram depicting an example machine learning architecture for copy detection.

FIG. 6 illustrates the output generation process diagram showing how classification results are transformed into usable outputs.

FIG. 7 is a network diagram depicting a cloud-based SaaS system within which various example embodiments may be deployed.

FIG. 8 is a block diagram illustrating example modules of the services and/or applications of FIG. 1.

FIG. 9 is a block diagram illustrating an example method of detecting copied text using keystroke analysis.

FIG. 10 is a block diagram illustrating an example user interface for displaying document authenticity analysis.

FIG. 11 is a block diagram illustrating an example administrative dashboard interface for managing document authenticity assessments.

FIG. 12 is a block diagram illustrating an example mobile device on which instructions may be executed to cause performance of any one or more of the operations or methodologies described herein.

FIG. 13 is a block diagram illustrating an example computer system on which instructions may be executed to cause performance of any one or more of the operations or methodologies described herein.

### DETAILED DESCRIPTION

Document authenticity verification has become increasingly critical in the digital age, particularly with the proliferation of sophisticated content generation and copying tools. Traditional approaches to detecting copied or artificially generated content have primarily relied on static analysis methods, comparing text passages against databases of existing content or analyzing linguistic patterns. These conventional methods, while effective for basic plagiarism detection, face significant limitations in addressing modern challenges.

The emergence of advanced language models and generative AI has fundamentally changed the landscape of content creation and validation. These AI systems can generate highly coherent and contextually appropriate text that often bypasses traditional plagiarism detection methods. Unlike direct copying (e.g., copying or plagiarizing of an existing work), which may leave traceable patterns in the text itself, AI-generated content can be unique while still not representing authentic human composition. Traditional content-matching algorithms and linguistic analysis tools struggle to distinguish between human-authored and AI-generated text, as the generated content often exhibits increasingly more natural language patterns and/or maintains internal consistency.

Furthermore, conventional plagiarism detection systems rely heavily on comparing documents against known sources and detecting subtle text alterations. These systems typically employ techniques such as fingerprinting, string matching, and stylometric analysis. However, they face several critical limitations in the modern content creation environment. They cannot effectively detect content copied from offline or private sources, are susceptible to deliberate text modifications, and require access to comprehensive source material databases. Additionally, these systems often generate false positives when encountering common phrases, standard terminology, or legitimately similar content.

Some systems have attempted to use keystroke dynamics with respect to user authentication. These approaches analyze typing patterns for identity verification and access control, requiring direct keystroke monitoring and continuous data collection. However, such systems are designed for user authentication, not copy detection, and they typically require specialized software installation and/or explicit user enrollment processes.

Advancements in document editing services have introduced new possibilities for content authentication. These platforms can be designed or configured to maintain detailed revision histories that capture how documents are created and modified, including timestamps, character-level changes, and/or position information. These histories may be used for version control, collaboration features, and audit trails. But they represent an untapped source of behavioral data that could provide insights into content authenticity.

Current document editing platforms offer sophisticated tracking capabilities, including real-time collaboration features and version control. However, these platforms utilize revision histories solely for document management purposes, such as enabling undo/redo functionality, change attribution, and maintaining audit trails. The behavioral patterns captured in these histories remain unexploited for authenticity verification.

Traditional authentication approaches face additional challenges in educational and professional environments, where the need to verify original content creation is particularly acute. Static analysis methods can be circumvented through careful content modification, and existing keystroke monitoring solutions are often too intrusive or impractical for widespread deployment.

In example embodiments, systems and methods that can reliably distinguish between authentically created and artificially generated or copied content are disclosed. In example embodiments, the disclosed methods and systems operate non-intrusively within existing document services, adapt to evolving content generation technologies, and/or provide reliable detection across different platforms without requiring access to source materials or specialized monitoring software. In example embodiments, a novel analysis of document revision histories is performed, enabling dynamic pattern-based detection that can adapt to emerging challenges in content authentication. In example embodiments, the novel analysis enables copy detection based on behavioral patterns rather than content matching.

In example embodiments, systems and methods are disclosed for detecting copied text through analysis of document revision history data. In various embodiments, the system interfaces with document editing services to obtain revision histories containing timestamps, character modifications, and/or position information. These histories undergo processing through a data pipeline that extracts and analyzes temporal and/or spatial patterns characteristic of authentic typing versus copied text.

Systems, methods, and non-transitory computer-readable storage media are disclosed for detecting copied text through analysis of document revision history data. One or more revision histories are retrieved (e.g., from document editing services). The one or more revision histories are processed to extract typing pattern features (e.g., including temporal intervals between modifications and/or spatial relationships between text insertions or deletions). Statistical patterns are computed across different time scales (e.g., by employing multiple sliding windows) to analyze character-level modifications and/or grouped editing events (e.g., modifications). These features are processed (e.g., using an application of one or more machine learning models) to distinguish between patterns characteristic of authentic typing versus copied text and/or using statistical analysis of natural language processing of the text. In example embodiments, a machine learning model is trained on authentic text examples, copied text examples, and/or typing test data normalized to match the document service behaviors. In example embodiments, one or more visual and/or programmatic outputs are generated indicating, for example, potential copied content, including segment-level authenticity assessments and/or confidence scores. In example embodiments, non-intrusive copy detection is provided without requiring access to source materials or direct keystroke monitoring.

In example embodiments, the system may implement a preprocessing classification stage that analyzes the semantic structure and content patterns of the text to determine its type or category (e.g., conclusion paragraph, bullet points, code sample, and/or citation-heavy supporting paragraph). This classification can be performed using natural language processing techniques to vectorize the text content and machine learning models trained on labeled examples of different text types. The preprocessing classifier may be trained using datasets of categorized academic papers, lab reports, essays and/or other document types to learn characteristic patterns.

Based on the identified text type, the system may adapt its feature extraction and analysis approaches. For example, conclusion paragraphs may warrant different statistical pattern analysis compared to sections containing code samples or bullet points. The system may adjust window sizes, feature calculations, and/or pattern detection thresholds based on the expected authentic typing patterns for different text categories. This adaptive processing enables more accurate copy detection by accounting for legitimate variations in how different types of content are typically authored.

The system provides particular advantages through its non-invasive integration with existing cloud-based document editing platforms. Unlike traditional proctoring systems that require specialized monitoring software and/or operate in closed environments, the present system can analyze revision history data from document editing services like Google Docs (e.g., through API integration). This enables copy detection even when the system is installed after document creation, as the complete revision history remains accessible. Furthermore, the system eliminates the need for any additional installations, external typing tools, or proctored text boxes. Users can simply submit their document (e.g., a Google Doc) directly, allowing for seamless and unobtrusive integration with their existing workflows while maintaining all core pattern analysis and copy detection capabilities.

The cloud integration approach allows the system to operate transparently within users'existing document creation workflows without requiring special monitoring software or behavioral changes. The ability to analyze pre-existing documents and operate non-intrusively (e.g., through cloud platform APIs) provides significant advantages over traditional keystroke monitoring approaches that require custom software installation and active tracking during document creation.

In example embodiments, the techniques described herein may find application in academic integrity monitoring, professional document verification, content authenticity assessment, digital document management, and/or cloud-based collaboration platforms. The field encompasses document revision history analysis, behavioral pattern detection, machine learning-based classification, cloud-based document service integration, and/or non-intrusive copy detection methods. The field may include an intersection of natural language processing, pattern recognition, behavioral analysis, cloud computing, and/or machine learning.

In example embodiments, the system processes revision history by reconstructing editing sequences and/or analyzing modification patterns. The system may segment documents based on natural boundaries such as sentences while maintaining positional indices for tracking modifications. This approach enables granular analysis of typing patterns and/or reconstruction of broader editing behaviors.

In example embodiments, the system implements feature extraction through multiple processing stages. In some embodiments, this includes maintaining sliding windows of varying sizes to capture patterns across different time scales. The system may compute statistical features within each window, such as temporal pattern variations, character density metrics, position jump distributions, and deletion pattern analysis. For example, windows ranging from 2 to 7 consecutive modifications may be used to calculate rolling statistics and detect characteristic patterns.

Training data preparation may involve multiple data sources and processing steps. The system can analyze typing test website data to generate examples of copied text patterns, as such data exhibits characteristics similar to copied content. The system may process authentic text examples from historical document revision histories to establish baseline typing patterns. In example embodiments, the system normalizes the typing test data using probability distributions that reflect typical demographic typing speeds, adjusting for the bias toward fast typists often found in typing test data. In example embodiments, the normalizations may include more specific demographics, such as student's year, location, etc.

The normalization process may include analyzing character-per-minute (CPM) distributions and creating probability maps for character grouping patterns. For example, the system can scale keystroke timings using empirically derived probability distributions that match typical typing speed demographics. The system may then apply service-specific grouping behaviors to these scaled timings, generating training data that accurately simulates how copied text appears in document revision histories. This process enables the creation of representative training datasets containing both authentic typing patterns and realistic copied text examples.

Through (e.g., SQL-based) data processing and probabilistic scaling, the system can transform raw typing test data into normalized training examples that exhibit the temporal and spatial patterns characteristic of copied text while matching the grouping behaviors of the target document service. This approach enables robust training of the machine learning model to supplement manual collection of copied text samples.

The machine learning analysis employs sequence processing to detect temporal patterns in the revision history. In example embodiments, a machine learning model (e.g., a neural network) architecture processes variable-length input sequences and adapts to different document service behaviors. The network may include components such as bidirectional sequence processing, attention mechanisms, temporal convolution, or hierarchical feature processing, though other architectures could be used to achieve similar results.

Output generation can take multiple forms depending on implementation requirements. The system may provide visual indicators of potentially copied content, programmatic interfaces for integration with other systems, or detailed analytics of typing patterns. Results can be generated at various granularities, from paragraph-level analysis to document-wide assessments.

The system's modular architecture enables adaptation to different document services while maintaining core pattern analysis capabilities. In some embodiments, the system analyzes service-specific character grouping behaviors and adjusts feature extraction accordingly. This flexibility allows the system to function across various platforms and document types while maintaining accurate copy detection.

Through this comprehensive approach to revision history analysis, the system provides non-intrusive copy detection without requiring access to source materials or direct keystroke monitoring. In example embodiments, novel use of typing pattern analysis and machine learning enables detection of copied content that might be missed by traditional content-matching approaches. In example embodiments, keystroke monitoring may be implemented as one or more extensions of one or more document editing services. Unlike conventional test proctoring applications, this monitoring would not need to be implemented at the operating system level.

In example embodiments, methods for detecting copied text through analysis of document revision history data are disclosed. In example embodiments, typing behavior patterns captured in document revision histories are analyzed, combining sophisticated pattern analysis with machine learning techniques to distinguish between authentic and copied content.

A method of detecting copied text using keystroke pattern analysis is disclosed. A set of raw revision history data items associated with creation of a document is received. The set of raw revision history data items pertains to one or more modifications made to the document during the creation of the document. The set of raw revision history data items is processed to identify one or more patterns in the set of raw revision history data items. The one or more patterns pertain to characteristics of how content was input into the document. A machine learning model is used to classify one or more portions of the document as either authentically created or copied based on the identifying of the one or more patterns. One or more indicators are caused to be presented in a user interface. The one or more indicators represent the classifying of the one or more portions of the document.

Convention approaches to detecting copied text face fundamental technical problems that the embodiments described herein solve through novel technical solutions. One technical challenge is the invasive nature of existing keystroke monitoring systems that require installation of custom web applications with JavaScript keystroke tracking to directly monitor every keystroke. Example embodiments described herein solve this through seamless integration with cloud-based document services via APIs, enabling non-intrusive collection of revision history data without requiring specialized monitoring software or browser extensions. This solution maintains comprehensive analysis capabilities while preserving the natural writing process.

Another technical problem that is addressed is the limited analytical capabilities of conventional systems that only capture basic character-level keystrokes and/or timing data. The present invention addresses this through sophisticated analysis of character grouping patterns and distributions in revision history data, enabling detection of copying even with coarser-grained data available through document service APIs. The system's ability to analyze how services like Google Docs group characters and examine the resulting distribution patterns represents a technical advancement.

The requirement of conventional systems to disable copy-paste functionality creates significant technical limitations in distinguishing legitimate content movement. In example embodiments described herein, this problem is solved through novel tracking of internal document reorganization that can differentiate between copied content and legitimate editing behaviors like moving text within the document. This position-based history tracking enables identification of sophisticated copying attempts while avoiding false positives from normal editing patterns.

The binary classification approach of conventional systems, which only provide basic alerts about copy-paste actions, presents a technical barrier to understanding detection results. In example embodiments described herein, sophisticated visualization systems are implemented showing statistical evidence through interactive highlighting and/or aligned analytical visualizations that explain the reasoning behind copy detection decisions. The system transforms complex pattern analysis into intuitive graphical representations showing how specific features deviate from baseline authentic writing behaviors.

Integration limitations of conventional systems that focus on standalone monitoring within custom environments create technical barriers to adoption. In example embodiments described herein, seamless integration is enabled with existing cloud platforms and/or learning management systems through APIs, allowing retroactive analysis of documents created before system installation. This technical solution maintains core pattern analysis capabilities while working within existing document creation workflows.

The validation problem of conventional systems, which provide no way to verify copy detection decisions, creates technical challenges in establishing trust and accuracy. In example embodiments described herein novel interactive playback visualization is implemented, showing actual typing patterns and/or statistical evidence to help users understand and validate copy detection results. This technical solution provides transparency into the decision-making process through sophisticated visual analysis tools.

The workflow limitations of conventional systems focusing only on individual document analysis create technical inefficiencies in managing multiple submissions. In example embodiments described herein, a comprehensive administrative interface is implemented for managing multiple submissions with status tracking, batch processing, and detailed analytical insights. This technical solution enables efficient management of document authenticity assessments while maintaining clear status tracking and streamlined access to detailed analysis data.

Security and privacy limitations in conventional systems due to invasive keystroke monitoring at the browser level create significant technical vulnerabilities. In example embodiments described herein, this is solved this through server-side processing of revision history data within the secure ecosystem of a document editing service, eliminating potential security risks from browser extensions having access to keystroke data and network calls. This architectural approach provides enhanced security while maintaining comprehensive analysis capabilities.

The drawings collectively illustrate the system's comprehensive approach to processing document revision histories, extracting meaningful features, training the machine learning model, and generating classification results. The figures are intended to aid understanding of described components and their interactions, though other implementations and variations are possible within the scope of the claims.

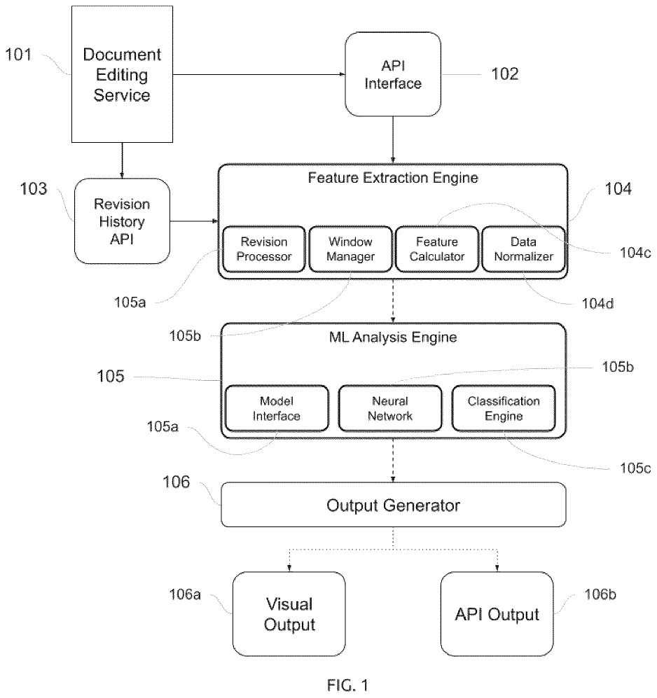

FIG. 1 illustrates a system architecture diagram showing the main components of the copy detection system. The diagram depicts the Document Editing Service, API Interface, Revision History API, Feature Extraction Engine with its Revision Processor, Window Manager, Feature Calculator, and Data Normalizer components, ML Analysis Engine including Model Interface, Neural Network, and Classification Engine components, and Output Generator with Visual and API output capabilities.

The system architecture, as illustrated in FIG. 1, comprises several interconnected components that work together to process document revision data and detect copied content. In one implementation, the system includes a document editing service 101 that interfaces with the detection system through an API interface 102. The document editing service may be any platform that maintains revision histories, whether cloud-based, local, or hybrid. In example embodiments, a revision history API 103 provides access to modification data, which may include timing information, character insertions, deletions, and position data. In example embodiments, revision history and/or keystrokes may be recorded directly into a local log and/or streamed directly to a storage system (e.g., cloud storage), by passing the need for a retrieval API.

The system's core processing functionality is implemented through three primary engines that may be deployed independently or as integrated components: the feature extraction engine 104, the ML analysis engine 105, and the output generator 106.

The feature extraction engine 104 processes raw revision data to identify behavioral patterns through four main components. The revision processor 104a handles the initial processing of raw modification data, which may be structured according to various formats containing sequences of modifications with associated metadata such as timestamps, character values, and position information.

The temporal pattern analyzer 104b examines the timing relationships between modifications across multiple scales. The analyzer may employ various temporal windows to capture both immediate typing patterns and broader editing behaviors, allowing detection of characteristic rhythms in authentic typing versus copied text.

The feature calculator 104c computes statistical measures that characterize the typing behavior. These calculations may span multiple dimensions including temporal patterns, spatial relationships, and modification characteristics. The system may analyze various aspects of typing behavior including but not limited to speed variations, correction patterns, and position-based relationships.

The data normalizer 104d adjusts input data to account for different editing environments and user behaviors. The normalization process may employ probability-based approaches to handle variations in typing speeds, editing patterns, and service-specific behaviors. This component ensures consistent analysis across different platforms while maintaining sensitivity to authentic typing patterns.

In example embodiments, the system implements sophisticated preprocessing capabilities that inform how subsequent feature extraction and/or machine learning analysis are performed. For example, during the reassembly and sentence boundary detection stage 202, statistical analysis may be performed on the revision history data to identify patterns that may indicate different types of content creation behaviors. This analysis may examine factors such as typing speed distributions, character grouping frequencies, and/or position change patterns to determine optimal processing strategies for different portions of the document.

Based on this initial statistical analysis, the system may adaptively configure how the Feature Extraction Engine 104 processes different document segments. For example, sections exhibiting unusually uniform typing patterns or suspicious position change frequencies may trigger more intensive feature extraction (e.g., with additional statistical metrics being computed across multiple window sizes). Conversely, sections showing typical authentic typing patterns may be processed using standard feature extraction parameters. This adaptive approach ensures suspicious content receives appropriate scrutiny while maintaining efficient processing of clearly authentic sections.

The ML Analysis Engine 105 implements the machine learning components through a model interface 105a, neural network 105b, and classification engine 105c. This engine processes the extracted features to distinguish between authentic and copied content using sophisticated pattern recognition techniques.

In example embodiments, the ML Analysis Engine 105 adapts its processing based on the preprocessing analysis. Document segments flagged as potentially suspicious during preprocessing may be routed through specialized machine learning (e.g., neural network) layers or receive additional attention mechanism focus. The system may also adjust classification thresholds and confidence requirements based on the statistical signatures identified during preprocessing. This pattern-aware processing enables the system to apply appropriate levels of analysis to different document portions while maintaining overall processing efficiency.

The output generator 106 produces both visual representations 106a and API outputs 106b of the analysis results. This component may generate various output formats suitable for different applications while maintaining the relationship between analyzed segments and their positions in the original document.

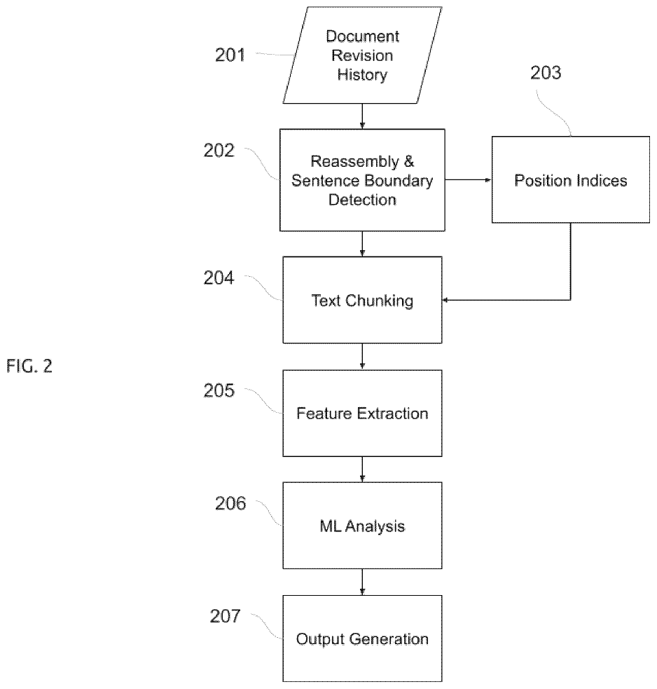

FIG. 2 shows a document processing pipeline diagram depicting the flow from raw revision history through text chunking and analysis to output generation. The pipeline illustrates a linear flow through Document Revision History, Reassembly & Sentence Boundary Detection, Position Indices, Text Chunking, Feature Extraction, ML Analysis, and Output Generation stages, with Position Indices feeding into the Text Chunking process.

The system processes document revision histories through a multi-stage pipeline designed to analyze typing patterns at varying levels of granularity. Referring to FIG. 2, the pipeline begins with raw document revision history 201 which may be obtained through various methods including but not limited to API calls, local file monitoring, or direct service integration.

In example embodiments, the revision history undergoes reassembly and/or sentence boundary detection 202. The system may reconstruct the document's evolution using position indices 203 to maintain spatial relationships between modifications. The position tracking system may maintain mappings between modifications and their locations within the document, allowing the system to analyze both temporal and spatial patterns in user editing behavior.

In example embodiments, during the reassembly process, the system analyzes the edit sequence numbers, timestamps, and/or session identification data associated with each modification to determine which modifications belong to distinct editing sequences. The system may trace the evolution of individual characters and/or character groups across multiple edit operations, maintaining a mapping between modifications that affect the same content across different positions and/or sessions. This sequence analysis enables the system to reconstruct coherent editing patterns even when content is moved, deleted, and/or reinserted across different parts of the document.

In example embodiments, the system employs one or more sophisticated tracking mechanisms to handle cases where content is cut and pasted within the same document, maintaining relationships between the original input sequence and subsequent modifications. When analyzing movement patterns, the system may consider temporal relationships between edits and/or spatial relationships between original and final positions of content. This detailed sequence tracking enables more accurate classification by preserving information about how content was originally input versus how it was later modified or repositioned.

For collaborative documents, the system may use user identification data to separate and analyze modification sequences from different contributors while maintaining the overall temporal ordering of edits. The session identification data may help partition modifications into coherent editing sessions, allowing the system to identify patterns that span multiple editing sessions while properly handling cases where content is modified across different sessions.

The system may employ various text chunking strategies 204 based on multiple segmentation approaches. The chunking process may consider natural language boundaries within the text, which could be determined through semantic analysis or statistical patterns. The system may also analyze temporal gaps in the modification sequence to identify natural breaking points in user typing behavior. Spatial relationships between edits may inform the chunking process, as may document structure elements such as paragraphs or sections. Additionally, the system may adapt its chunking strategy based on observed user editing patterns to optimize the granularity of analysis.

In example embodiments, during the chunking process, the system analyzes statistical characteristics of each sequence or chunk to determine its type classification. These classifications may include chunks exhibiting uniform typing patterns indicative of copying, chunks showing natural variation typical of authentic typing, chunks containing frequent position changes suggesting editing and revision, and/or chunks with timing patterns matching known copying behaviors. The chunk type classifications may be passed to subsequent processing stages to inform how the content should be analyzed.

In example embodiments, the Feature Extraction Engine 104 adapts its processing approach based on the chunk type classification. For chunks classified as potentially copied based on their statistical signatures, the engine may compute additional features across multiple window sizes, analyze timing patterns at finer granularity, and/or apply specialized feature extraction algorithms optimized for detecting copying patterns. Conversely, chunks classified as likely authentic may undergo standard feature extraction to maintain processing efficiency.

Similarly, the ML Analysis Engine 105 may receive the chunk type classifications to guide its analysis strategy. Chunks flagged as suspicious during the chunking phase may be processed using specialized machine learning (e.g., neural network) layers or receive increased attention mechanism focus during classification. The engine may also adjust classification thresholds and confidence requirements based on the initial chunk type assessment. This adaptive processing ensures appropriate scrutiny is applied to different content portions while maintaining overall system performance.

The feature extraction stage 205 processes these chunks through the temporal pattern analyzer and feature calculator to generate comprehensive behavioral signatures. The ML analysis component 206 then processes these signatures to assess content authenticity, leading to the output generation stage 207 which produces both visual and programmatic results.

The pipeline may include multiple preprocessing stages to handle different document formats and revision structures, adapting to variations in typing speed, modification patterns, and spatial relationships across document services. Probabilistic models can be employed to normalize these patterns, considering factors like typical typing speed distributions, common editing groupings, and characteristic timing relationships between modifications. By leveraging empirically derived probability distributions, the system can dynamically adjust its processing, ensuring consistency across document services while remaining flexible to their unique behaviors.

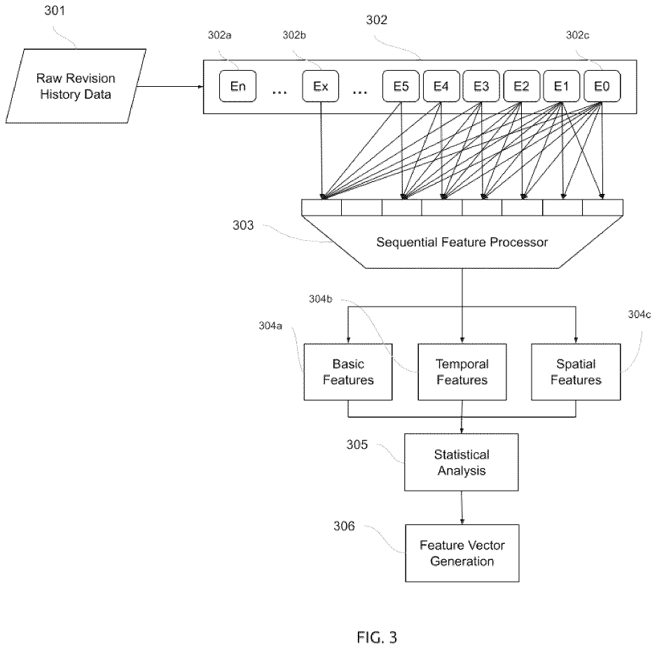

FIG. 3 illustrates a detailed feature extraction process diagram showing how raw revision history data is processed through multiple stages. The diagram depicts the flow from Raw Revision History Data through Event Processing Chain (showing En to E0 events), Sequential Feature Processor, Feature Types including Basic Features, Temporal Features, and Spatial Features, Statistical Analysis, and Feature Vector Generation.

The feature extraction process analyzes document modifications to identify patterns indicative of authentic versus copied content. As illustrated in FIG. 3, the process begins with raw revision history data 301 which undergoes multiple stages of analysis through the temporal pattern analyzer and feature calculator to generate comprehensive feature vectors.

The system processes sequences of editing events 302 through the revision processor, which handles different types of modifications such as insertions 302a and deletions 302b while maintaining their temporal and spatial relationships 302c. The revision processor may analyze each modification's type, timing, and context within the broader editing sequence.

The temporal pattern analyzer 303 examines the modification sequence across multiple time scales to identify characteristic patterns. This component may analyze various aspects of typing behavior including speed variations, pause patterns, and rhythmic characteristics that distinguish authentic typing from copied content.

The system generates multiple categories of features through the feature calculator 304. These include basic modification characteristics 304a such as timing and character counts, temporal patterns 304b capturing typing rhythms and speed variations, and spatial features 304c analyzing relationships between modification positions.

The statistical analysis component 305 computes distributions and patterns within these features, considering both local and global characteristics of the typing behavior. These computations may incorporate multiple statistical measures to capture different aspects of authentic versus copied text patterns. The feature vector generation process 306 combines these analyses into comprehensive representations of typing behavior suitable for machine learning analysis.

The feature extraction process adapts to different document service behaviors through the data normalizer, which employs probabilistic modeling of modification patterns. The system may learn characteristic grouping behaviors, timing relationships, and editing patterns specific to different platforms while maintaining the ability to detect fundamental differences between authentic and copied content.

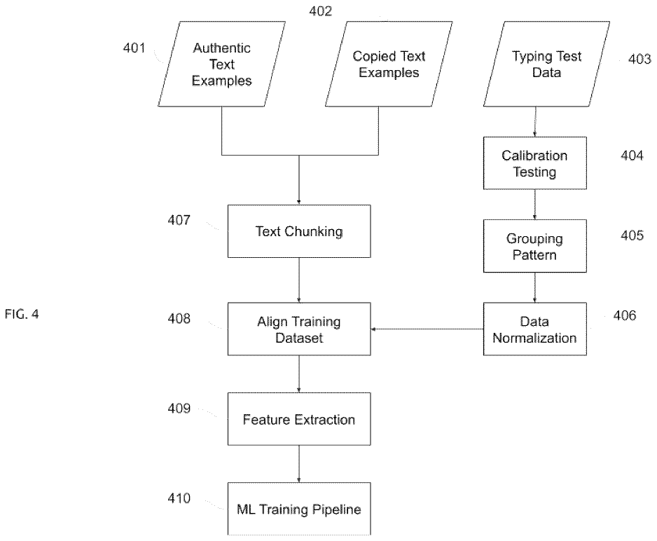

FIG. 4 depicts a training data processing diagram showing the preparation of both authentic and copied text examples. The diagram illustrates the parallel processing of Authentic Text Examples, Copied Text Examples, and Typing Test Data through a linear flow of Calibration Testing, Grouping Pattern, Data Normalization, Text Chunking, Align Training Dataset, Feature Extraction, and ML Training Pipeline stages.

The training data preparation process implements a sophisticated approach to developing the system's pattern recognition capabilities. Referring to FIG. 4, the process combines multiple data sources to create a comprehensive training dataset that enables the system to distinguish between authentic and copied content patterns.

The system processes authentic text examples 401 obtained from verified document revision histories. These examples may come from various document editing environments and user populations, providing a broad representation of natural typing patterns. The revision histories capture the temporal and spatial characteristics of genuine human typing behavior across different contexts and writing styles.

Copied text examples 402 may be derived from multiple sources using various copying methods. These examples help the system understand the characteristic patterns that emerge when users paste or manually transcribe existing content. The system may analyze how different copying methods affect the temporal and spatial patterns in the revision history.

The system incorporates typing test data 403 to understand baseline typing behaviors under controlled conditions. This data undergoes calibration testing 404 to analyze how users interact with different interfaces and how their typing patterns vary across different speeds and contexts.

The grouping pattern analysis 405 examines how document editing services process and record rapid sequences of modifications. This empirical analysis reveals characteristic patterns in how services aggregate modifications, which may vary between authentic typing and copied content. The system develops probabilistic models of these grouping behaviors to improve its pattern recognition capabilities.

The data normalization process 406 applies empirically derived patterns to adjust training data for consistent analysis. This stage may scale temporal patterns based on typing speed distributions, adjust modification groupings based on service behavior models, and normalize spatial patterns to account for different editing environments.

Text chunking 407 segments the training data into analyzable units while preserving contextual relationships. The chunking process considers multiple factors including semantic boundaries, temporal patterns, and modification relationships to create meaningful analysis units.

The training data alignment process 408 combines the processed chunks into a unified dataset that maintains the temporal and spatial relationships between modifications. The feature extraction stage 409 then applies the same processing pipeline used for runtime analysis to generate consistent feature vectors for training.

The ML training pipeline 410 processes this carefully prepared dataset to develop robust pattern recognition capabilities. The pipeline may adapt to different sequence lengths and document service behaviors while maintaining its ability to distinguish fundamental patterns of authentic versus copied content.

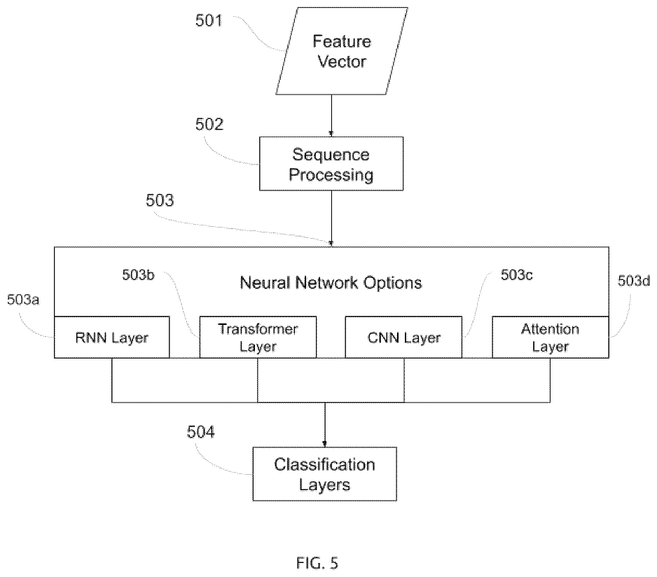

FIG. 5 is a block diagram showing an example of a machine learning analysis architecture used for copy detection. The diagram depicts the flow from Feature Vector through Sequence Processing and various neural network components including RNN Layer, Transformer Layer, CNN Layer, and Attention Layer, culminating in Classification Layers.

The machine learning analysis system, illustrated in FIG. 5, implements a sophisticated pattern recognition approach through multiple specialized components. The process begins with feature vectors 501 generated by the feature extraction engine, which capture the multi-dimensional characteristics of typing behavior across various time scales and modification types.

The sequence processing component 502 analyzes the temporal evolution of typing patterns through multiple specialized neural network components. This sequential analysis captures both immediate patterns and longer-term relationships in typing behavior that help distinguish between authentic and copied content.

The neural network architecture 503 incorporates multiple processing approaches designed to capture different aspects of typing behavior. The RNN component (503a) processes the sequential nature of typing patterns, maintaining temporal context across the document and detecting natural rhythm variations versus artificial consistency.

The transformer component 503b implements self-attention mechanisms to identify relationships between modifications across different time scales. This approach helps capture global document editing patterns and context-dependent typing behaviors that may indicate copied content.

The CNN component 503c analyzes local patterns through temporal convolution, identifying characteristic groups of modifications that may distinguish between authentic and copied text. The attention mechanism 503d learns to focus on the most relevant features for classification, particularly suspicious timing patterns or unusual editing sequences.

The classification component 504 processes the combined outputs of these neural network components to generate authenticity assessments. The system may produce both categorical classifications and confidence scores, enabling flexible decision thresholds for different application contexts.

The machine learning analysis may be implemented through various machine-learning (e.g., neural network) architectures and approaches suited for sequence processing and pattern recognition. While one implementation may utilize a long short-term memory (LSTM) recurrent neural network with attention mechanisms, other architectures may be equally suitable, including but not limited to, transformer networks for processing sequential patterns, convolutional neural networks for analyzing local feature relationships, hybrid architectures combining multiple network types, and/or other sequence processing approaches.

The system may employ different machine learning techniques for feature processing and classification, such as supervised learning with labeled training data, semi-supervised approaches incorporating unlabeled examples, or alternative classification algorithms. The specific architecture and training approach may be selected based on factors including but not limited to: available training data characteristics, computational resources, accuracy requirements, and/or processing speed needs.

The machine learning implementation may incorporate various components in different configurations, such as multiple processing layers for hierarchical feature analysis, skip connections between layers, different attention mechanism implementations, various activation functions, and/or alternative layer architectures. The model training process may utilize different optimization algorithms, loss functions, and/or hyperparameter configurations while maintaining the core ability to distinguish between authentic and copied content based on revision history patterns.

The system supports adaptation of the machine learning implementation to different use cases through configurable model architectures, adjustable training parameters, and/or flexible feature processing approaches. This enables optimization of the analysis pipeline for specific deployment scenarios while preserving the fundamental capability to detect copied content through revision history pattern analysis.

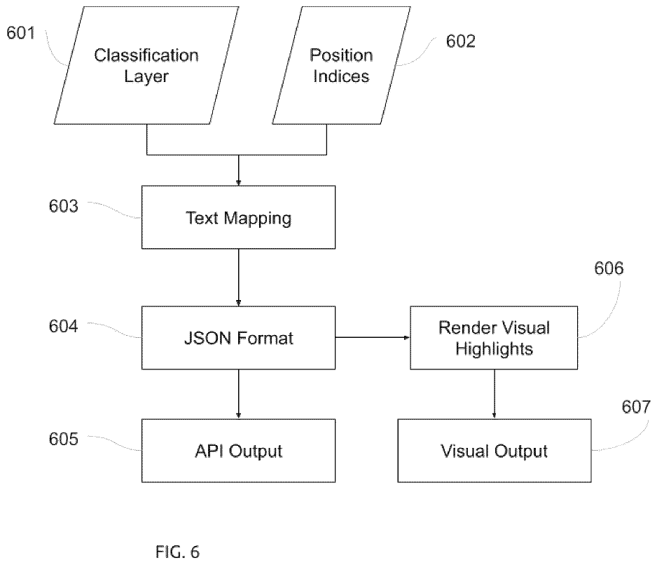

FIG. 6 illustrates the output generation process diagram showing how classification results are transformed into usable outputs. The diagram shows the flow from Classification Layer and Position Indices through Text Mapping to JSON Format, which then splits into two paths: API Output and Render Visual Highlights leading to Visual Output. This process enables both programmatic integration and visual representation of copy detection results.

The output generation process, illustrated in FIG. 6, produces both visual and programmatic representations of the authenticity analysis results. The system begins with inputs from the classification component 601 which provides authenticity assessments for document segments. These assessments are combined with position indices 602 that maintain precise mappings between classifications and document locations.

The text mapping component 603 integrates the classification results with the document structure to create a comprehensive representation of content authenticity. This mapping preserves both the spatial organization of the text and the corresponding analysis results, enabling precise identification of potentially copied segments within their full context.

The system generates a standardized intermediate format containing segment classifications, position information, confidence metrics, and analysis results. This structured representation may include authenticity scores, feature patterns, and temporal analysis results while maintaining relationships between different aspects of the analysis.

For programmatic integration, the system generates structured outputs suitable for various applications and platforms. These outputs may include segment-level classifications, detailed feature analyses, position-mapped results, and confidence metrics, enabling flexible integration with different document editing systems. These outputs may include visual graphs or charts showing statistics of the typed text and its relation to the model's mean and standard deviation of various statistics of various features.

In example embodiments, the system generates detailed statistical visualizations that provide transparency into the classification process. These visualizations may include graphs showing the distribution of typing speeds, character grouping patterns, and/or position change frequencies for the analyzed text compared to baseline statistics derived from the training data. The system displays how specific features of the analyzed text relate to the mean and standard deviation of corresponding features from known authentic and copied samples.

For each analyzed portion, the system may generate statistical breakdowns showing how different feature categories contributed to the classification decision. This includes visualization of temporal patterns like typing rhythm consistency, spatial patterns like position change frequency, and/or character grouping patterns. The visualizations highlight when specific patterns deviate significantly from typical authentic writing behaviors, providing concrete evidence to support classification decisions.

The system may present multi-dimensional visualizations showing how different feature combinations interact, such as the relationship between typing speed variation and character grouping sizes across different window sizes. These detailed analytics enable users to understand which specific behavioral patterns triggered classification decisions, distinguishing this approach from black-box solutions that provide only final determinations without supporting evidence.

The statistical visualizations may adapt based on the analyzed content, highlighting the most relevant patterns for each classification decision. For suspicious content, the system may emphasize the specific statistical anomalies that contributed to the classification, such as unusually consistent typing speeds or atypical editing patterns. This evidence-based approach provides transparency into the decision-making process while maintaining the system's ability to detect sophisticated copying attempts.

The visual rendering process 606 transforms the analysis results into interactive displays that aid in understanding and validating the authenticity assessment. The final visual output 607 may present the analysis through various representations including modified text highlighting, confidence indicators, and pattern visualizations, while maintaining precise mappings to the original document content.

The system implements various adaptation mechanisms to handle different document editing environments and usage patterns. The service-specific adaptation processes analyze and account for differences in how various editing platforms record and report modifications. These adaptations may include customized grouping pattern analysis, timing normalizations, and integration patterns suited to different service behaviors.

The implementation includes performance optimization mechanisms that enable efficient processing of document changes. These optimizations may include incremental analysis of modifications, strategic feature computation, and efficient sequence processing approaches that maintain accuracy while reducing computational overhead.

The system implements privacy and security measures throughout its processing pipeline. These measures may include anonymized feature extraction, secure communication channels, and configurable data handling policies that protect user privacy while maintaining analysis capabilities.

The system supports various implementations of its core technology through multiple adaptation mechanisms. The probability modeling system may implement different distribution models for various typing speeds and usage patterns. These models may adapt to language-specific patterns, input device characteristics, and user proficiency levels while maintaining consistent analysis capabilities.

Service-specific adaptations enable the system to process revision histories from different platforms effectively. These adaptations may include customized behavioral analysis, platform-specific normalizations, and modified feature extraction approaches based on available revision history granularity and platform characteristics.

The machine learning architecture may be implemented through various network configurations adapted to different analysis requirements. These configurations may include modified sequence processing approaches, alternative attention mechanisms, or specialized models for specific languages or character sets while maintaining the core ability to distinguish between authentic and copied content.

The feature extraction system may implement various analysis approaches based on document characteristics and processing requirements. These approaches may include dynamic temporal analysis windows, alternative statistical measures, and context-aware feature computation methods that maintain classification accuracy across different usage patterns.

In example embodiments, a method for detecting copied text is disclosed, the method comprising retrieving document revision history data from a document editing service; processing the revision history data to extract typing pattern features by analyzing temporal relationships between consecutive modifications in the revision history data, computing statistical features characterizing modification patterns, the statistical features comprising temporal pattern variations, character grouping densities, position distributions between modifications, and/or deletion patterns; normalizing the computed features based on statistical patterns derived from aggregate user interaction data collected from the document editing service, wherein the statistical patterns comprise typing speeds, character grouping frequencies, and modification timing distributions; analyzing the normalized features using a machine learning model trained on a combination of typing test data adjusted according to population-based typing speed statistics, known copied document revision histories, and verified authentic document revision histories; generating an authenticity score indicating a relative likelihood of copied content; and providing an indication of whether the text input includes copied content based on comparing the authenticity score to a configurable threshold.

In example embodiments, the processing of the revision history data comprises extracting keystroke timestamps, identifying character insertion positions, tracking deletion events, and/or analyzing document modification patterns.

In example embodiments, the extracting of the temporal and spatial features comprises calculating time intervals between text modifications; determining character group patterns; analyzing position jumps between edits; and/or computing typing speed variations.

In example embodiments, the machine learning model comprises a sequence processing neural network configured to analyze temporal patterns in the revision history data.

In example embodiments, the sequence processing neural network comprises at least one of a recurrent neural network, a transformer network, a convolutional neural network, or an attention-based network.

In example embodiments, the processing of the revision history data comprises grouping consecutive modifications into character clusters and/or calculating features for each cluster, the features including one or more of cluster duration, cluster size, inter-cluster timing, or cluster position relationships.

In example embodiments, the revision history data comprises, for each modification event, calculating multiple windows backwards from the current event, each window comprising a different number of consecutive modification events starting from at least two consecutive events and/or computing statistical features within each window, the features including one or more of temporal pattern variations, character density metrics, position jump statistics, or deletion pattern analysis.

In example embodiments, the computing of the statistical features comprises calculating, for each window, characters and time within the window, rolling mean and standard deviation of modification timing, rolling standard deviation of characters per millisecond, deletion pattern frequencies, mean and standard deviation of position jumps between modifications, average character density, count of high-density modifications, and/or count of timing gaps.

In example embodiments, providing the indication comprises generating a probability score for copied content, comparing the score to configurable thresholds, and/or providing a classification result.

In example embodiments, a document revision history is retrieved from a cloud-based document service; typing pattern features are extracted from the revision history using sliding windows; the features are analyzed using a machine learning model; and/or an assessment of whether document content includes copied text is generated.

In example embodiments, the processing the revision history data comprises segmenting the document into chunks based on sentence boundaries; processing each chunk independently to generate chunk-level authenticity assessments; and/or reassembling the results to provide document-level copy detection.

In example embodiments, indices mapping chunk-level results to document positions are maintained; assessments are updated when modifications occur within previously analyzed chunks; and/or visual indicators of potentially copied content locations are provided.

In example embodiments, the analyzing of the extracted features comprises analyzing patterns in the revision history data based on empirically determined character grouping behaviors of the cloud-based document service; calculating typing speed distributions across multiple time windows; normalizing features based on probabilistic grouping patterns; and/or computing statistical features across multiple sliding windows of varying sizes, the features including temporal pattern variations, character density metrics, position jump distributions, and/or deletion pattern analysis.

In example embodiments, the machine learning model is trained using typing test website data normalized using empirically derived probability distributions; authentic text samples from historical document revision histories; and/or character grouping pattern data derived from cloud-based document service behavior; wherein the training data preparation comprises scaling keystroke timings based on typing speed distributions, grouping characters based on probabilistic timing thresholds, computing multi-window statistical features, and/or generating sequence-based feature vectors.

In example embodiments, the normalizing of the typing test data comprises computing character grouping probability maps from document service revision patterns; applying probabilistic grouping thresholds based on timing distributions; scaling keystroke timings to match target typing speed distributions; and/or generating grouped modification events that simulate document service behavior, including temporal pattern matching, position-based grouping, and/or deletion pattern simulation.

In example embodiments, the generating of the grouped modification events comprises maintaining a probability map of character group sizes based on timing windows; analyzing temporal gaps between modifications; computing statistical features within sliding windows, the features including character density metrics, deletion patterns, position jump distributions, and/or inter-group timing patterns; and/or calculating rolling statistics across multiple window sizes.

In example embodiments, the sliding windows comprise multiple window sizes for consecutive modification events, each window size generating distinct statistical features, the features including temporal pattern variations, character group densities, position jump distributions, deletion pattern analysis, timing gap detection, and/or high-density modification clusters.

In example embodiments, a probability distribution model of copied text patterns is generated based on typing test website data, character per minute (CPM) distributions, and/or modification timing patterns; the probability distribution model is used to scale keystroke timings, group character modifications, and/or simulate copied text behavior; and/or training data that represents copied text patterns is generated.

In example embodiments, processing the revision history data comprises analyzing document service-specific character grouping behaviors, creating a service-specific grouping model, applying the grouping model to normalize input data; and/or adjusting feature extraction based on service-specific behaviors.

In example embodiments, the machine learning model comprises a sequential processing network comprising an input layer configured to receive the normalized features, at least one hidden layer configured to process sequential patterns in the normalized features, and/or an output layer configured to generate the authenticity score, wherein the network implements at least one of bidirectional sequence processing, attention mechanisms, temporal convolution, or hierarchical feature processing.

In example embodiments, a system for detecting copied text is disclosed, the system comprising: a probability modeling engine configured to analyze document service behavior, generate grouping pattern models, and/or normalize input data; a feature extraction engine configured to process multiple time scales, compute statistical patterns, and/or generate sequence-based features; and/or a machine learning engine configured to process variable-length sequences and/or classify text authenticity.

In example embodiments, a system for detecting copied text is disclosed, the system comprising an API interface or local text editor extension configured to retrieve granular revision history data, wherein the API interface is configured to retrieve the data from a cloud-based document service, or the local text editor extension is configured to capture keystroke data and generate corresponding revision history data; a feature extraction engine is configured to compute windowed statistical features from the revision history data; a cloud-based machine learning analysis engine is trained on authenticated typing patterns; and/or a results reporting interface is configured to provide authenticity assessments.

In example embodiments, the feature extraction engine is configured to process revision history data in batches; maintain sliding windows of modification patterns; compute statistical metrics within each window; and/or normalize features for machine learning analysis.

In example embodiments, the system implements a preprocessing stage that uses machine learning to perform early classification of the type of text being analyzed. This preprocessing classifier may analyze characteristics of the revision history data to determine the general category or style of the text, such as academic writing, creative writing, technical documentation, or other text types. Based on this initial classification, the system may select and apply one or more specialized machine learning models that have been specifically trained on revision patterns typical of that text category.

The one or more specialized models may be optimized for detecting copying patterns within their respective text categories, taking into account characteristic editing behaviors, typical revision sequences, and/or common modification patterns associated with different types of writing. For example, academic writing may exhibit different authentic typing and editing patterns compared to creative writing, warranting different feature extraction approaches and classification thresholds. This adaptive model selection enables more accurate copy detection by accounting for variation in legitimate writing and editing behaviors across different text types.

The preprocessing classification may also inform subsequent processing stages about expected pattern distributions and typical statistical signatures for the identified text category. This enables the feature extraction and analysis components to adjust their parameters and thresholds appropriately, improving the system's ability to distinguish between authentic and copied content within the specific context of the writing type.

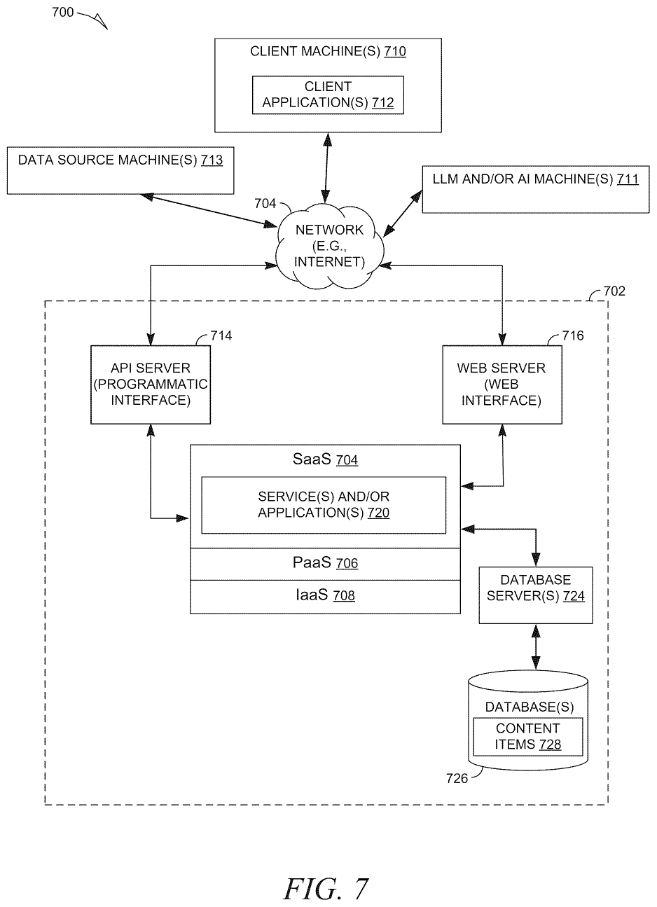

FIG. 7 is a network diagram depicting a cloud-based SaaS system within which various example embodiments may be deployed and/or executed. A networked system 702, in the example form of a cloud computing service, such as Microsoft Azure or other cloud service, provides server-side functionality, via a network 704 (e.g., the Internet or Wide Area Network (WAN)) to one or more endpoints (e.g., client machines 710). FIG. 7 illustrates client application(s) 712 on the client machines 110. Examples of client application(s) 712 may include a web browser application, such as the Internet Explorer browser developed by Microsoft Corporation of Redmond, Washington or other applications supported by an operating system of the device, such as applications supported by Windows, iOS or Android operating systems. Each of the client application(s) 712 may include a software application module (e.g., a plug-in, add-in, or macro) that adds a specific service or feature to the application.

An Application Programming Interface (API) server 714 and a web server 716 are coupled to, and provide programmatic and web interfaces respectively to, the services 720, which may be hosted on a software-as-a-service (SaaS) layer or platform 704. The SaaS platform may be part of a service-oriented architecture, being stacked upon a platform-as-a-service (PaaS) layer 706 which, may be, in turn, stacked upon a infrastructure-as-a-service (IaaS) layer 708 (e.g., in accordance with standards defined by the National Institute of Standards and Technology (NIST)).

While the services 720 are shown in FIG. 7 to form part of the networked system 702, in alternative embodiments, the applications 720 may form part of a service that is separate and distinct from the networked system 702.

Further, while the system 700 shown in FIG. 7 employs a cloud-based architecture, various embodiments are, of course, not limited to such an architecture, and could equally well find application in a client-server, distributed, or peer-to-peer system, for example. The services 720 could also be implemented as standalone software programs.

Web applications executing on the client machine(s) 710 may access the services or applications 720 via the web interface supported by the web server 716. Similarly, native applications executing on the client machine(s) 710 may access the services 720 via the programmatic interface provided by the API server 714.

The services 720 may be hosted on dedicated or shared server machines that are communicatively coupled to enable communications between servers. The services 720 themselves are communicatively coupled to each other and to various data sources, including the content items 728 stored in the database(s) 726 via the database servers 724.

Navigation of the content items 728 stored in the networked system 702 may be facilitated by one or more navigation applications. For example, a search application may enable keyword searches of the content items 728. A browser application may allow users to browse the content items 728.

In example embodiments, external data stores 713 containing supplemental information may be accessed via network 704. These external data stores 713 may include documents, raw modification data associated with the documents, and/or metadata derived from the raw modification data, including any of the metadata described herein. By leveraging these external data items, services 720 can perform any of the operations described herein (e.g., to perform detection of copied text).

In example embodiments, the system architecture illustrated in FIG. 1 may be implemented within the cloud-based Software-as-a-Service (SaaS) layer 704 shown in FIG. 7. For example, the Document Editing Service 101 may be provided by client machines 710 running client applications 712, while the core copy detection functionality may be implemented within the services and applications 720 running on the SaaS layer.

The API Interface 102 and Revision History API 103 components may map to the API Server 714, which provides the programmatic interface for accessing revision history data. The Feature Extraction Engine 104, ML Analysis Engine 105, and Output Generator 106 may be implemented as services within the SaaS layer 704, leveraging the underlying Platform-as-a-Service (PaaS) 706 and Infrastructure-as-a-Service (IaaS) 708 resources for computation and storage.

The system's databases containing training data, model parameters, and/or user feedback may be stored within the databases 726 accessed via database servers 724. External data sources 713 may provide supplementary training data or typing test data used to train the machine learning models. The Web Server 716 enables delivery of the visual output 106a through web interfaces, while the API Output 106b is provided through the API Server 714.

The modular architecture enables flexible deployment across different cloud infrastructure components while maintaining the core pattern analysis and copy detection capabilities. The Feature Extraction Engine 104 and ML Analysis Engine 105 can scale horizontally across PaaS/IaaS resources as processing demands increase. User interface components are delivered through standard web and API interfaces, allowing integration with various client applications while keeping the complex analysis pipelines within the secure cloud environment.

In example embodiments, the Document Editing Service 101 may represent Google Docs and/or other document editing services, while third-party systems like Google Classroom are integrated into the system (e.g., through the API Interface 102). The Revision History API 103 accesses the underlying edit data regardless of which service originated it.

In example embodiments, Google Classroom or similar third-party systems may operate as a Client Application 712 running on Client Machines 710, interfacing with the core copy detection system (e.g., through both the API Server 714 and Web Server 716). The classroom system integration may be implemented within the Services/Applications 720 layer, specifically handling: automatic submission processing through the API interface, class enrollment and assignment management, and/or student/teacher access controls, integration with revision history of a document editing service.

The system may maintain separation between the core copy detection functionality (implemented in the SaaS layer 704) and third-party integrations. This may allow the system to: support multiple document platforms, handle submissions through different classroom management systems, maintain consistent analysis regardless of the source platform, and/or enable flexible deployment across different cloud infrastructure components.

The modular architecture allows third-party systems to integrate through standardized APIs while keeping the complex analysis pipelines secure within the cloud environment. The system can scale horizontally across PaaS/IaaS resources as processing demands increase from multiple integrated platforms.

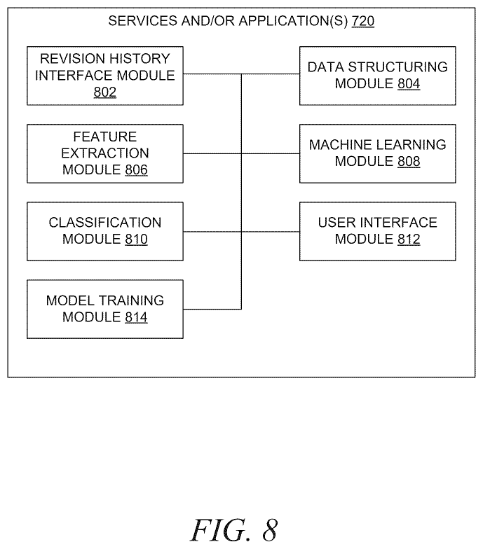

FIG. 8 is a block diagram illustrating example modules of the services and/or applications of FIG. 7.

A Revision History Interface Module 802 may be configured to access revision history data. In example embodiments, the revision history data may be accessed using one or more APIs. In example embodiments, the APIs may be undocumented APIs discovered through system analysis. In example embodiments, one or more secure connections may be established for retrieving raw edit objects (e.g., representing one or more modifications). The raw edit objects may contain insertions of a predetermined number of characters (e.g., 1-3 characters) based on the service's data capture distribution, deletions, and/or nested multi-edit operations that contain multiple insertions or deletions. In example embodiments, associated metadata may be processed. This metadata may include, for example, precise timestamps for each modification, sequential edit sequence numbers for maintaining modification order, user identification data for tracking edits in collaborative environments, session identification data that changes whenever the page is refreshed or revisited, character position data indicating exact locations of modifications within documents, and/or additional formatting attributes like italics and bold styling. The module may be further configured to (e.g., through add-ons) handle integration with classroom products, such as Google Classroom, enable automatic submission processing, and/or support multiple cloud-based document platforms.

A Data Structuring Module 804 is configured to transform sequential edit data into overlapping windows of edit objects. In example embodiments, the window ranges may be chosen (e.g., through experimental optimization) to balance computational efficiency with pattern detection, maintain temporal relationships between edits while reducing noise from individual position changes, normalize input data to create consistent feature sets regardless of document length or editing patterns, process multiple window sizes in parallel to enable detection of patterns at different time scales, track movement of characters across multiple edit objects by tracing the revision history of each character, determine edit sequence patterns across editing sessions identified by session IDs, organize structured data into standardized formats optimized for statistical analysis and feature extraction, and/or support iterative refinement of the windowing approach based on classification performance.

In example embodiments, the Data Structuring Module 804 is configured to maintain a comprehensive position-based history of the document by tracking the evolution of content at each character position over time. For each position in the document, the system may record when it transitions from empty to containing specific characters, subsequent character modifications at that position, and/or temporal gaps between modifications. For example, a given position may remain empty for a configurable number of edits and/or time period (e.g., the first 200 edits or 10 minutes before receiving its first character), followed by additional modifications as the document evolves.

This position-based tracking enables analysis of how content emerges and changes throughout the document creation process. The system may monitor patterns in how positions are populated, including the sequence and timing of initial character insertions, the frequency of modifications at each position, and/or temporal relationships between edits at nearby positions. These position-based patterns provide additional signals for distinguishing between authentic typing, where positions are typically populated in a natural sequence, versus copied content, which may exhibit unusual patterns in how positions are filled.

The position history data may be integrated with the window-based analysis to provide multiple complementary views of the document's evolution. While the windowing approach captures sequential patterns in editing behavior, the position-based tracking reveals spatial patterns in how content materializes across the document. This dual analysis strengthens the system's ability to detect sophisticated copying attempts that might appear natural from just one analytical perspective.

A Feature Extraction Module 806 is configured to analyze time intervals between sequential edits within each window to establish typing speed patterns, calculate sums of characters modified within windows, compute statistical patterns including standard deviations and rolling averages of typing rhythms, track aggregate movement statistics indicating frequency and types of content position changes rather than specific positions to reduce noise, determine character grouping patterns by examining how text is input in chunks versus character-by-character, generate a comprehensive set of 76 distinct features including typing speed statistics and grouping patterns across different window sizes (e.g., 2-7 edits), calculate rolling averages and standard deviations for timing patterns, and/or prepare normalized feature vectors optimized for machine learning analysis while preserving key pattern indicators.

A Machine Learning Module 808 is configured to implement a machine learning model, such as a long short-term memory (LSTM) recurrent neural network, specifically chosen for time series analysis. The Machine Learning Module 808 may be further configured to process windowed patterns in revision history data, identify features most important for distinguishing authentic from copied content (e.g., utilizing an attention mechanism), maintain separate training and validation datasets with a configurable split (e.g., an 80/20 split), such as datasets comprising a million rows of data or more, analyze patterns across different time scales using the windowed feature sets, process time series data through multiple layers to capture complex temporal relationships, implement parallel processing for training efficiency, and/or coordinate model deployment across distributed systems.

A Classification Module 810 is configured to process extracted features (e.g., through the trained machine learning model), generate probability scores (e.g., between 0 and 100 percent) indicating likelihood of copying for document portions, apply configurable classification thresholds to identify suspicious content, produce overall and/or granular classification results for document segments, analyze time series patterns (e.g., using the machine-learning model network's ability to maintain state across sequences of inputs, leverage the attention mechanism to identify which features within each window are most relevant for classification, and/or provide detailed statistical metrics about the classification confidence for each analyzed portion.

A User Interface Module 812 is configured to display documents with visual highlighting of portions classified as copied, enable clicking on highlighted sections to toggle classification status, provide probability scores adjacent to highlighted portions (e.g., “98% copied”), implement scrubber-style playback controls for time-based visualization of content input, allow adjustment of probability score thresholds for classification and highlighting, capture user feedback regarding classification accuracy, display class enrollment information and/or assignment details, provide integration with classroom product interfaces, enable creation and/or management of classes and assignments, support enrollment code distribution, and/or facilitate document submission workflows (e.g., through classroom product integration).

A Model Training Module 814 is configured to manage training datasets comprising authentic essays written prior to AI text generation tools and/or copied writing samples scraped from typing tests, process typing test data to match document service granularity through custom data transformation pipelines, incorporate user feedback from the interface to create additional training data, update model weights while maintaining the configured training/validation split, track accuracy metrics for continuous model improvement, handle parallel processing of training data across multiple instances with crash recovery and/or synchronization mechanisms, coordinate training processes across distributed systems, implement checkpointing for validation of intermediate results, and/or support continuous model refinement based on user feedback and classification performance.

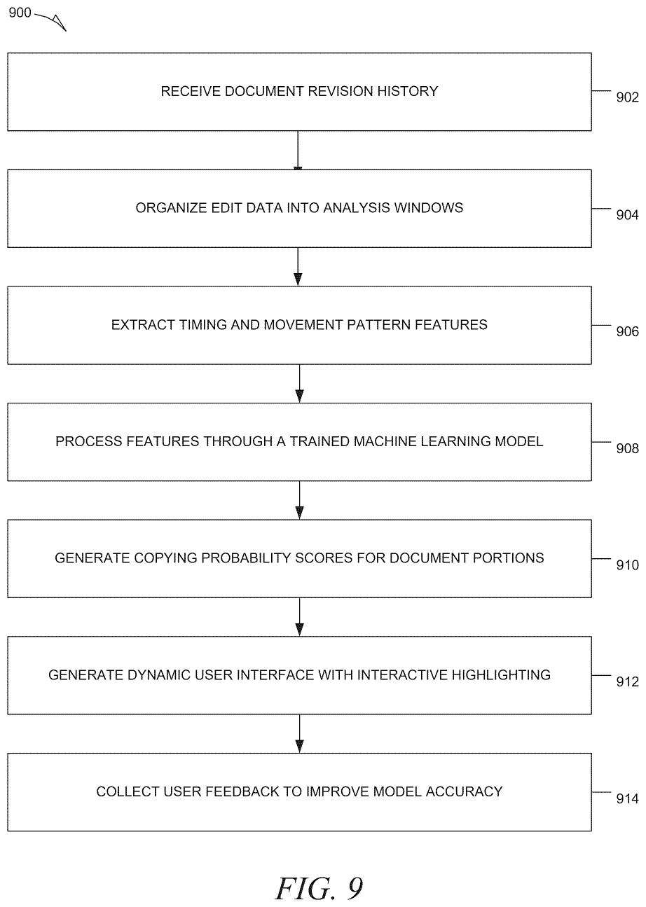

FIG. 9 is a block diagram illustrating an example method of detecting copied text.

At operation 902, a set of revision history data items associated with creation of a document is accessed or received. In example embodiments, the revision history is received via an API of a document editing service, such as a cloud-based document editing service. The received data may include a sequential list of edit objects, where each edit object is classified as an insert, delete, or multi-edit operation. For insert operations, the edit object may contain one or more specific characters or character sequences that were inserted within a character time range based on the document service's data capture distribution. Each edit object may include one or more of a precise timestamp indicating when the modification occurred, a unique edit sequence number for maintaining modification order, a user ID for tracking which user performed the edit in collaborative environments, a session ID that changes whenever the page is refreshed or revisited, and/or position data tracking where in the document the modification occurred. Additional metadata like text formatting attributes (e.g., italics or bold) may also be captured but may not necessarily be utilized for analysis.

At operation 904, the set of raw revision history data items is organized into overlapping sequential windows of edit objects. Configurable ranges of window sizes (e.g., ranging from 2-7) for sequential edits may be chosen (e.g., through experimental optimization) to balance computational efficiency with pattern detection capabilities. This structuring may transform the sequential edit data into standardized chunks that can be analyzed independently while preserving temporal relationships. Multiple window sizes may be used in parallel to enable detection of patterns that may only become apparent when examining different groupings of sequential edits. The windowing approach may also help to normalize inputs for the machine learning model regardless of overall document length or varying editing patterns.

In example embodiments, the system implements time-based windowing to capture editing patterns across temporal gaps. The system may analyze how many edit objects occur within defined time windows, accounting for cases where a writer may make edits elsewhere in the document before returning to continue editing a particular sequence. This temporal analysis may help distinguish between continuous authentic typing patterns and discontinuous editing that may indicate copying behavior.

The time-based windows may enable detection of natural writing rhythms versus artificial patterns, as authentic writing typically exhibits consistent timing even when the writer moves between different document sections. The system may track the distribution of edits across time windows, analyzing factors such as edit density, timing consistency, and/or patterns in how content emerges after temporal gaps. This analysis may help identify cases where copied content may be inserted with timing patterns that deviate from the writer's natural rhythm.

In example embodiments, the system integrates both sequential and temporal windowing approaches to build a comprehensive view of the document's evolution. While sequential windows capture immediate editing patterns, time-based windows reveal broader behavioral patterns in how content is created across different writing sessions and document sections. This dual windowing strategy may strengthen the system's ability to detect sophisticated copying attempts that might appear natural from just one analytical perspective.

At operation 906, one or more features are extracted from each window of revision history data (e.g., through one or more analysis steps). Time intervals between sequential edits within each window may be analyzed to establish typing speed patterns and rhythms. Character grouping patterns may be determined by examining how text is input (e.g., in chunks versus character-by-character). Movement patterns may be tracked by analyzing how content positions change throughout the document, focusing on frequency of movements rather than specific position changes to reduce noise. Statistical metrics, such as standard deviations and rolling averages, may be computed across different window sizes to capture typing consistency and/or variation. The feature extraction process may focus on aggregate statistics rather than granular position tracking to improve computational efficiency while maintaining pattern detection capabilities.

At operation 908, the extracted features are provided to a machine learning model. In example embodiments, the machine learning model is implemented using a long short-term memory (LSTM) recurrent neural network architecture specifically chosen for its ability to process time series data. The model may be trained using two distinct datasets: authentic writing samples collected from essays (e.g., written prior to general availability of LLMs, such as ChatGPT), and copied writing samples obtained by scraping typing test data that captures keystroke patterns of users copying text word-for-word. The typing test data may undergo additional processing to match the granularity of the document service's data capture. A configurable amount of the total data (e.g., twenty percent of the total data) is reserved for validation testing. The model may implement an attention mechanism to identify features that are most important for distinguishing between authentic and copied content.

At operation 910, the machine learning model generates probability scores (e.g., between 0 and 100 percent) indicating likelihood of copying. The classification may be performed by analyzing time series patterns (e.g., using the LSTM network's ability to maintain state across sequences of inputs). An attention mechanism may help to identify which features within each window are most relevant for classification. The model may produce an overall probability score and/or one or more granular scores for specific portions of the document.

At operation 912, the document is displayed in a user interface with visual highlighting applied to portions classified as copied. The user interface may enable clicking on highlighted sections to toggle classification status, provide probability scores adjacent to highlighted portions, include a scrubber-style playback control that displays a time-based visualization of how content was input into the document, and/or allow adjustment of probability score thresholds used for classification and highlighting. The playback visualization may show the document being reconstructed edit by edit, allowing manual verification of suspicious patterns.

At operation 914, user input received through the interface indicating whether portions were correctly or incorrectly classified is stored, along with the associated revision history data, as additional training data. This feedback is combined with the original training datasets of authentic and copied writing samples to retrain the model. The retraining process may use the same LSTM architecture and/or attention mechanism, but update the model weights based on the expanded training data, enabling continuous improvement of classification accuracy. The validation dataset is also expanded proportionally to maintain the configured split between training and validation data.

The method illustrated in FIG. 9 provides improvements over prior art approaches to detecting copied text. While traditional plagiarism detection tools rely solely on comparing text against databases of source material, the present system implements a novel multi-stage analysis pipeline that examines the actual creation process of the document through revision history data.

Rather than simply flagging potential matches or requiring explicit installation of monitoring tools, the system provides sophisticated visualization tools that display statistical evidence of copying through interactive highlighting and aligned analytical visualizations. This enables users to understand the specific behavioral patterns that triggered copy detection, providing transparency that is absent from traditional “black box” detection approaches.

The system's integration with cloud-based document services through APIs enables non-intrusive monitoring without requiring specialized keystroke logging software or browser extensions. Unlike prior art systems that require custom web applications with JavaScript keystroke tracking, the present system can analyze documents retroactively using revision history data that is automatically captured by document services like Google Docs.

The system's ability to track internal document reorganization and distinguish between copied content and legitimately moved text provides advantages over systems that simply detect copy-paste operations or require disabling of copy-paste functionality. By maintaining a comprehensive position-based history of how content emerges and evolves within the document, the system can identify sophisticated copying attempts while avoiding false positives from normal editing behaviors.

The system implements novel statistical visualization capabilities that transform complex pattern analysis into intuitive graphical representations, showing how specific features deviate from baseline authentic writing behaviors. This evidence-based approach provides concrete justification for copy detection decisions through aligned visualizations rather than relying on simple binary classification or alerts to teachers.

The system's administrative interface provides comprehensive submission tracking and analysis capabilities beyond simple plagiarism detection, enabling efficient management of document authenticity assessments across multiple submissions while maintaining clear status tracking and detailed analytical insights. The integration with learning management systems and batch processing capabilities further enhance administrative workflow efficiency compared to traditional approaches that focus only on individual document analysis.

The system's ability to analyze character grouping patterns in the revision history data represents a key improvement over character-level keystroke logging. By examining how a document editing service groups characters and analyzing the distribution patterns, the system can detect copying even with the more coarse-grained data available through an API of the document editing service.

The system's playback visualization capabilities provide unique advantages for understanding potential copying, allowing users to observe the actual typing patterns rather than just receiving binary alerts about copy-paste actions as described in the prior art. This temporal visualization helps users make informed decisions about authenticity by showing how content emerged over time.

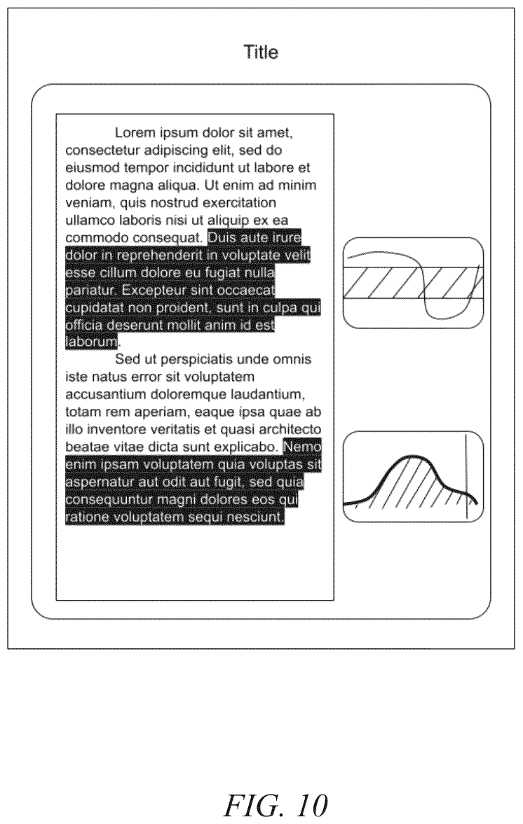

FIG. 10 illustrates an example user interface for displaying document authenticity analysis. In example embodiments, the user interface provides unique visualization capabilities for understanding and/or validating copy detection results. The interface may include a display region containing a text rendering area that presents document content in its natural readable format while enabling sophisticated analytical overlays. The text rendering area implements a novel highlighting system that visually distinguishes potentially copied sections through highlighting (e.g., selective background color modification), allowing rapid identification of suspicious content while maintaining readability.

Adjacent to the display region are one or more specialized annotation regions comprising one or more graphical display panels that are spatially aligned with their corresponding highlighted text sections. These annotation regions implement a novel multi-dimensional visualization system that simultaneously displays multiple analytical metrics through integrated graphical elements. The visualization system may include one or more time-series graphs depicting typing pattern anomalies, distribution charts showing statistical deviations from authentic typing behaviors, and/or confidence indicators that quantify the likelihood of copying.

In example embodiments, the user interface implements a novel spatial correlation system that maintains visual alignment between highlighted text sections and their corresponding analytical visualizations. This system enables users to intuitively associate specific passages with their underlying statistical evidence while preserving the natural flow of document review. The spatial correlation may be maintained dynamically as users scroll through the document or adjust the viewing window.

The user interface further provides one or more interactive capabilities that allow users to investigate suspicious content in detail. Users can click on highlighted sections to access additional analytical details, toggle classification status based on manual review, and/or adjust visualization parameters (e.g., to focus on specific patterns of interest). The system also includes a novel playback mechanism that provides time-based visualization of how content was input, allowing direct observation of typing patterns that triggered the copy detection.

In example embodiments, the visualization system may implement one or more novel statistical displays that transform complex pattern analysis into intuitive graphical representations. These displays show how specific features like typing speed variations, character grouping patterns, and/or position change frequencies compare to baseline statistics derived from verified authentic writing samples. The system highlights statistically significant deviations that contribute to copy detection decisions, providing transparency into the classification process.

Through this integrated display architecture, the user interface enables simultaneous presentation of document content and sophisticated authenticity analysis while maintaining an intuitive and efficient user experience. The novel visualization and interaction capabilities provide unique advantages for understanding and validating copy detection results compared to traditional binary classification approaches.

The user interface further enables users to review document content in its natural flow while rapidly identifying suspected copied content through the visual highlighting system. The correlation between highlighted text sections and their corresponding analytical metrics is maintained through spatial alignment and/or visual linking mechanisms, providing clear organization and intuitive interaction patterns.

The system may additionally include user interaction capabilities with highlighted sections and corresponding analytical data, enabling detailed examination of specific copy detection results and the statistical evidence supporting those determinations. These interactive elements maintain the system's focus on providing transparent, evidence-based authenticity analysis through an intuitive and efficient interface.

A method of displaying and analyzing document authenticity through a specialized user interface is disclosed. The method includes displaying, in a display region of a user interface, textual content of a document in a readable format; displaying, in one or more annotation regions adjacent to the primary display region, graphical display panels comprising statistical visualizations of typing pattern data associated with portions of the textual content; visually distinguishing, within the primary display region, one or more sections of the textual content identified as potentially copied through background color modification; maintaining spatial alignment between the visually distinguished sections in the primary display region and corresponding statistical visualizations in the graphical display panels; displaying, within the graphical display panels, time-series graphs depicting typing pattern anomalies and distribution charts showing deviations from authentic typing behaviors for the corresponding visually distinguished sections; providing interactive controls enabling playback visualization of how content was input for the visually distinguished sections; and/or updating the visual distinctions and statistical visualizations in response to user feedback regarding classification of the one or more sections.

A user interface system for displaying document authenticity analysis is disclosed.

A display region configured to present textual content, wherein said display region includes a text rendering area for displaying document content in a readable format and/or a highlighting mechanism configured to visually distinguish sections of text identified as potentially copied (e.g., through highlighting, such as a background color modification); one or more annotation regions adjacent to the primary display region, wherein each annotation region comprises a graphical display panel spatially aligned with corresponding highlighted text sections, means for rendering statistical visualizations including but not limited to time-series graphs depicting typing pattern anomalies, distribution charts showing deviation from authentic typing behaviors, visual indicators of confidence levels in copy detection results.

In example embodiments, the system further comprises means for correlating highlighted text sections with their corresponding analytical data through spatial alignment and/or visual linking mechanisms, thereby enabling users to review document content in its natural flow, rapidly identify suspected copied content through visual highlighting, comprehend the statistical basis for copy detection determinations through aligned analytical visualizations, and/or associate specific text passages with their corresponding analytical metrics.

Through this integrated display architecture, the system enables simultaneous presentation of document content and authenticity analysis while maintaining clear visual organization and intuitive user interaction patterns.

The system may further include means for user interaction with highlighted sections and corresponding analytical data, enabling detailed examination of specific copy detection results and associated statistical evidence.

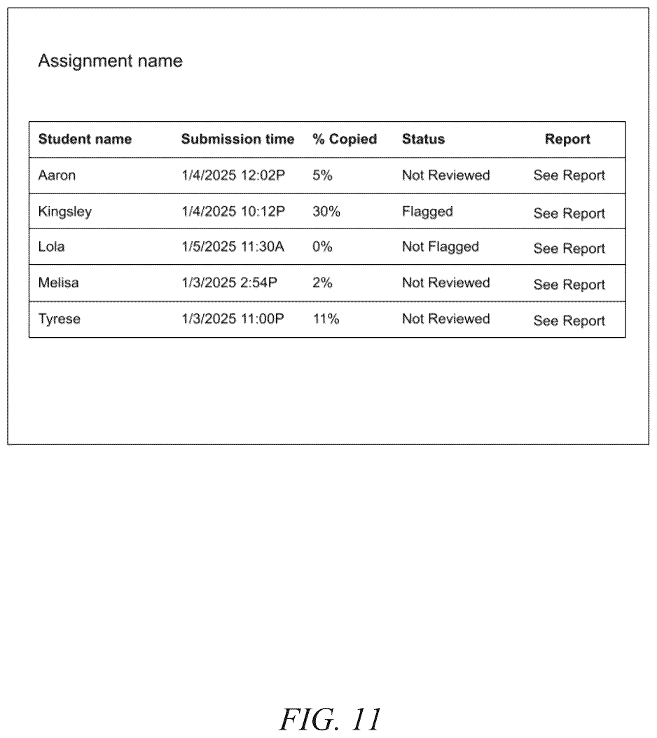

FIG. 11 illustrates an example administrative dashboard interface for managing document authenticity assessments. The dashboard interface includes a header region displaying the assignment name and/or one or more column headers for organizing submission data. The data presentation region comprises one or more rows containing student submission information, with each row displaying the student name, submission timestamp, percentage of detected copied content, review status, and/or an interactive report access link.

The dashboard interface implements a novel tabular organization system that enables efficient monitoring of multiple submissions simultaneously. The submission time field displays standardized temporal data indicating when each document was submitted. The percentage copied field provides quantitative assessment values indicating the proportion of potentially copied content detected by the system's analysis.

The status indication field implements a novel multi-state classification system that can display different review states including “Not Reviewed” for submissions awaiting assessment, “Flagged” for submissions identified as potentially containing copied content, and “Not Flagged” for submissions cleared through review. This status tracking enables administrators to efficiently monitor the progress of document authenticity reviews across multiple submissions.

The dashboard interface provides interactive elements (e.g., through the “See Report” links) that enable rapid navigation to detailed analysis reports for each submission. When clicked, these links open the comprehensive document analysis view shown in FIG. 10, maintaining an integrated workflow between the high-level submission overview and detailed authenticity assessments.

The dashboard interface implements a novel sorting and filtering system that allows administrators to organize submissions based on multiple criteria including submission time, percentage copied, and/or review status. This enables efficient identification of high-risk submissions that require immediate attention, such as those with high percentages of potentially copied content.

Through this organizational architecture, the dashboard interface enables administrators to quickly identify high-risk submissions through percentage indicators, track review progress through status indicators, and/or access detailed authenticity reports through embedded navigation elements. The system maintains comprehensive tracking of submission metadata while providing streamlined access to the detailed analysis capabilities.

In example embodiments, the dashboard interface further implements batch processing capabilities that allow administrators to efficiently handle multiple submissions simultaneously. The system can automatically flag submissions exceeding configurable percentage thresholds, enabling proactive identification of potential academic integrity concerns.

The dashboard interface integrates seamlessly with external learning management systems like Google Classroom, automatically processing submissions and updating status indicators as new documents are received. This integration maintains efficient workflow by eliminating manual submission handling while preserving comprehensive tracking capabilities.

The system maintains an administrative audit trail that tracks review decisions and/or status changes, preserving accountability throughout the document authenticity assessment process. This tracking includes timestamps of review actions, reviewer identification, and/or any notes or justifications provided during the review process.

The dashboard interface provides statistical analysis capabilities that can identify patterns across submissions, such as unusual submission timing or correlated copying percentages that may indicate coordinated academic integrity violations. These analytics enhance the system's ability to detect sophisticated copying attempts while maintaining efficient administrative workflows.

A method for managing document authenticity assessments is disclosed. The method comprises: displaying, in a header region of a user interface, an assignment identifier; displaying, in a data presentation region of the user interface, a table comprising one or more rows, each row corresponding to a document submission and/or including a student identifier field, a submission timestamp field, a percentage copied field indicating a proportion of potentially copied content, a review status field configured to display multiple review states, and/or an interactive report access element; enabling sorting of the rows based on one or more of the fields; updating the review status field for a submission in response to administrator review decisions; providing navigation to a detailed authenticity analysis interface in response to selection of the interactive report access element; displaying statistical analysis of submission patterns across multiple documents; maintaining an administrative audit trail of review decisions and status changes; and/or integrating with external learning management systems to automatically process new submissions.

In example embodiments, the system comprises a tabular display interface configured to present submission analysis results, wherein said interface includes a header region displaying assignment identification means, column headers for organizing submission data; a data presentation region comprising one or more rows, each row containing submitter identification field, temporal submission data field configured to display date and time information, quantitative assessment field displaying percentage values of detected copied content, status indication field configured to display multiple review states including but not limited to unreviewed status, flagged status, cleared status, interactive element field containing report access mechanisms.

In example embodiments, the system further comprises means for sorting submissions based on multiple criteria, means for displaying submission timestamps in a standardized format, mechanisms for status updates based on manual review decisions hyperlink integration enabling navigation to detailed analysis reports. In example embodiments, the interface enables administrative users to monitor multiple submissions simultaneously, identify high-risk submissions through percentage indicators, track review progress through status indicators, access detailed authenticity reports through embedded navigation elements, and/or update submission status based on manual review determinations.

Through this organizational interface architecture, the system facilitates efficient management of multiple document authenticity assessments while maintaining clear status tracking and streamlined access to detailed analysis data.

In example embodiments, the system may further include means for filtering submissions based on various criteria, batch processing of multiple submissions, statistical analysis of submission patterns, administrative audit trail maintenance, and/or integration with external learning management systems.

This dashboard interface enables efficient workflow management for document authenticity review processes while maintaining comprehensive tracking and reporting capabilities.

### Example Mobile Device

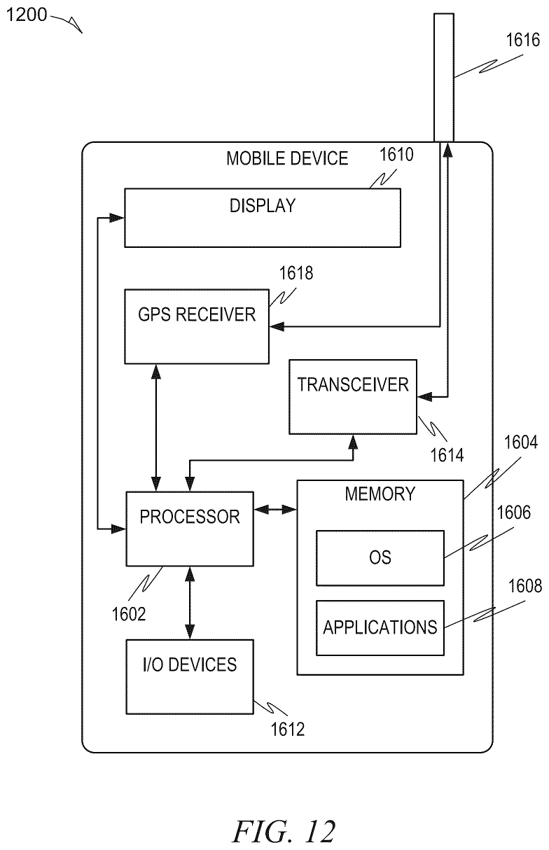

FIG. 12 is a block diagram illustrating an example mobile device on which instructions may be executed to cause performance of any one or more of the operations or methodologies described herein. The mobile device 1200 can include a processor 1602. The processor 1602 can be any of a variety of different types of commercially available processors suitable for mobile devices 1200 (for example, an XScale architecture microprocessor, a Microprocessor without Interlocked Pipeline Stages (MIPS) architecture processor, or another type of processor). A memory 1604, such as a random access memory (RAM), a Flash memory, or other type of memory, is typically accessible to the processor 1602. The memory 1604 can be adapted to store an operating system (OS) 1606, as well as application programs 1608, such as a mobile location-enabled application that can provide location-based services (LBSs) to a user. The processor 1602 can be coupled, either directly or via appropriate intermediary hardware, to a display 1610 and to one or more input/output (I/O) devices 1612, such as a keypad, a touch panel sensor, a microphone, and the like. Similarly, in some embodiments, the processor 1602 can be coupled to a transceiver 1614 that interfaces with an antenna 1616. The transceiver 1614 can be configured to both transmit and receive cellular network signals, wireless data signals, or other types of signals via the antenna 1616, depending on the nature of the mobile device 1200. Further, in some configurations, a GPS receiver 1618 can also make use of the antenna 1616 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In various example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

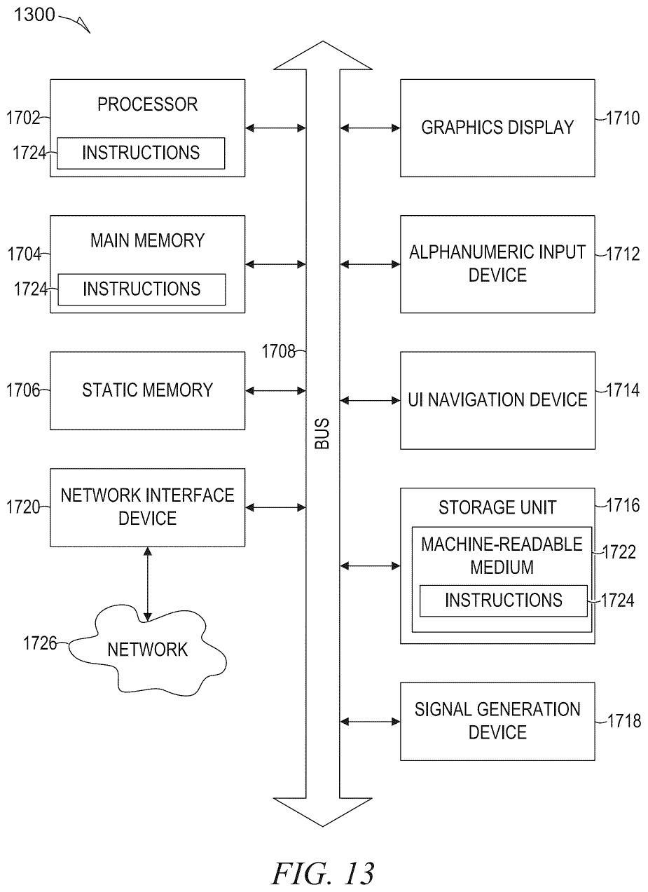

FIG. 13 is a block diagram illustrating an example computer system on which instructions may be executed to cause performance of any one or more of the operations or methodologies described herein.

In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1702 (e.g., a central processing unit (CPU), a graphics processing unit (GPU) or both), a main memory 1704 and a static memory 1706, which communicate with each other via a bus 1708. The computer system 1300 may further include a graphics display unit 1710 (e.g., a liquid crystal display (LCD) or a cathode ray tube (CRT)). The computer system 1300 also includes an alphanumeric input device 1712 (e.g., a keyboard or a touch-sensitive display screen), a user interface (UI) navigation device 1714 (e.g., a mouse), a storage unit 1716, a signal generation device 1718 (e.g., a speaker) and a network interface device 1720.

### Machine-Readable Medium

The storage unit 1716 includes a machine-readable medium 1722 on which is stored one or more sets of instructions and data structures (e.g., software) 1724 embodying or utilized by any one or more of the methodologies, operations, or functions described herein. The instructions 1724 may also reside, completely or at least partially, within the main memory 1704 and/or within the processor 1702 during execution thereof by the computer system 1300, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, and/or associated caches and servers) that store the one or more instructions 1724 or data structures. The term “machine-readable medium” shall also be taken to include any tangible medium that is capable of storing, encoding or carrying instructions (e.g., instructions 1724) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more computer processors;
one or more computer memories;
a set of instructions stored in the one or more computer memories, the set of instructions configuring the one or more computer processors to perform operations, the operations comprising:
receiving a set of raw revision history data items associated with creation of a document, the set of raw revision history data items pertaining to one or more modifications made to the document during the creation of the document;
processing the set of raw revision history data items to identify one or more patterns in the set of raw revision history data items, the one or more patterns pertaining to characteristics of how content was input into the document;
using a machine learning model to classify one or more portions of the document as either authentically created or copied based on the identifying of the one or more patterns; and
causing one or more indicators to be presented in a user interface, the one or more indicators representing the classifying of the one or more portions of the document.

2. The system of claim 1, wherein the set of raw revision history data items comprises one or more of edit objects indicating insertions, deletions, attribute changes, and multi-edit operations made to the document; timestamp data associated with each edit object; edit sequence numbers indicating an order of modifications; user identification data indicating which user made each modification; session identification data indicating distinct editing sessions; character position data indicating locations of modifications within the document; and position character data where each static position keeps track of what edits take place.

3. The system of claim 1, wherein the set of raw revision history data items are generated by a document editing service during creation of the document within the document editing service and the set of raw revision history data items are accessed from the document editing service.

4. The system of claim 1, wherein the processing of the set of raw revision history data items comprises organizing the set of raw revision history data items into sequential windows of edit objects and, for each window, calculating a sum of characters modified within the window, determining time intervals between edits within the window, and tracking aggregate movement statistics indicating frequency of content position changes within the window, wherein the identified one or more patterns are based on calculations performed across multiple window sizes.

5. The system of claim 1, wherein the processing the set of raw revision history data items comprises extracting features from the set of raw revision history data items by one or more of calculating typing speed statistics based on time intervals between sequential edits, determining character grouping patterns indicating how characters are input in chunks, tracking revision patterns including frequency and types of content movements within the document, or generating statistical metrics including standard deviations and rolling averages of the typing speed statistics and grouping patterns.

6. The system of claim 1, wherein the machine learning model is configured to analyze time series patterns in the set of revision history data items, identify features that distinguish between authentic and copied content using an attention mechanism, and generate a probability score indicating likelihood that portions of the document were copied based on the analyzed time series patterns.

7. The system of claim 6, wherein the user interface is configured to display the probability score adjacent to a graphical representation of each analyzed portion.

8. The system of claim 6, wherein the user interface is configured to apply different visual highlighting styles based on probability score thresholds.

9. The system of claim 6, wherein the user interface is configured to enable filtering of displayed portions based on probability score ranges.

10. The system of claim 6, wherein the user interface is configured to allow manual adjustment of probability score thresholds used for classification and highlighting.

11. The system of claim 1, wherein the causing of the one or more indicators to be presented in the user interface comprises displaying the document in the user interface with visual highlighting of portions classified as copied.

12. The system of claim 1, the operations further comprising enabling selection of highlighted portions to toggle classification status.

13. The system of claim 1, the operations further comprising providing a playback interface that displays a time-based visualization of how content was input into the document associated with the one or more indicators.

14. The system of claim 1, the operations further comprising presenting statistical metrics indicating likelihood of copying for selected portions of the document.

15. The system of claim 1, the operations further comprising training the machine learning model using a first dataset comprising authentic writing samples associated with the set of raw revision history data items and a second dataset comprising copied writing samples.

16. The system of claim 1, the operations further comprising informing selection of the machine learning model in subsequent processing based on validation of the machine-learning model.

17. The system of claim 1, the operations further comprising using metrics measuring an ability of the machine learning model to distinguish between authentic and copied content, wherein the machine learning model is configured to process time series patterns in the set of raw revision history data items.

18. The system of claim 1, the operations further comprising:
receiving, via the user interface, user input indicating whether portions of the document were correctly or incorrectly classified;
storing the user input and associated set of raw revision history data items as additional training data;
retraining the machine learning model using the additional training data from the user input and one or more sets of original training data items comprising authentic and copied writing samples; and
updating classification results for subsequently analyzed documents using the retrained machine learning model.

19. A method comprising:
receiving a set of raw revision history data items associated with creation of a document, the set of raw revision history data items pertaining to one or more modifications made to the document during the creation of the document;
processing the set of raw revision history data items to identify one or more patterns in the set of raw revision history data items, the one or more patterns pertaining to characteristics of how content was input into the document;
using a machine learning model to classify one or more portions of the document as either authentically created or copied based on the identifying of the one or more patterns; and
causing one or more indicators to be presented in a user interface, the one or more indicators representing the classifying of the one or more portions of the document.

20. A non-transitory computer-readable storage medium storing a set of instructions that, when executed by one or more computer processors, cause the one or more computer processors to perform operations, the operations comprising:
receiving a set of raw revision history data items associated with creation of a document, the set of raw revision history data items pertaining to one or more modifications made to the document during the creation of the document;
processing the set of raw revision history data items to identify one or more patterns in the set of raw revision history data items, the one or more patterns pertaining to characteristics of how content was input into the document;
using a machine learning model to classify one or more portions of the document as either authentically created or copied based on the identifying of the one or more patterns; and
causing one or more indicators to be presented in a user interface, the one or more indicators representing the classifying of the one or more portions of the document.
